(19) United States
(12) Patent Application Publication
(10) Pub. No.: US 2017/0161649 A1
(43) Pub. Date: Jun. 8, 2017

(54) INSTANT RENTAL SERVICE RESERVATION SYSTEMS AND METHODS

(71) Applicant: Wal-Mart Stores, Inc., Bentonville, AR (US)

(72) Inventors: Kevin Matthew Charles, Bentonville, AR (US); David Scot Harlow, Rogers, AR (US)

(21) Appl. No.: 15/370,801

(22) Filed: Dec. 6, 2016

Related U.S. Application Data
(60) Provisional application No. 62/263,873, filed on Dec. 7, 2015.

(51) Int. Cl. G06Q 10/02; H04W 4/12; H04L 29/08; G06Q 30/06

(52) U.S. Cl. CPC G06Q 10/02; G06Q 30/0645; G06Q 30/0631; H04W 4/12; H04L 67/10

(57) ABSTRACT

A rental service reservation system comprises an instant rental service reservation system that receives an electronic communication from an electronic device of a store customer requesting an item or service rental reservation and an analytics system that determines from the electronic communication whether the requested item or service is available for reservation, and generates a reservation recommendation to the instant rental service reservation system. The instant rental service reservation system generates a reservation in response to the reservation recommendation.

### RELATED APPLICATIONS

This application claims priority to U.S. Provisional Patent Application No. 62/263,873, filed Dec. 7, 2015 and entitled “Instant Rental Service Reservation Systems and Methods,” the entirety of which is incorporated by reference herein.

### FIELD

The present inventive concepts relate to rental reservation services, and more specifically, to systems and methods for providing scheduling and reservation services to a mobile device user.

### BACKGROUND

Customers who need to reserve a particular product of interest from a store typically call the store in advance to determine whether the product is in stock, whether it is available for rental, and/or the cost of the rental. However, the product may not be available for rental at the particular store. In other cases, a customer may visit a store to rent a product, only to discover that another customer has already reserved the same product. In other cases, the store may not carry the product of interest for rental, which is not known to the customer in advance of the customer's visit to the store.

### BRIEF SUMMARY

In one aspect, provided is an instant rental service reservation system, comprising: an input for receiving an electronic communication from an electronic device of a store customer requesting an item or service rental reservation; a text message processing module that generates revised text data by removing irrelevant content from the electronic communication, the revised text data including reservation request data; and a reservation determination module that generates a reservation from a reservation recommendation, the reservation recommendation generated in response to an analysis of the reservation request data of the revised text data.

In some embodiments, the instant rental service reservation system further comprises a token processing module processes a reservation electronic token unique to the generated reservation.

In some embodiments, the token processing module compares the reservation electronic token to a token database to establish that the reservation is not duplicated.

In some embodiments, the instant rental service reservation system further comprises a storage device interface that communicates with the token database for at least one of storing the reservation electronic token or providing interface for the token processing module to compare the reservation electronic token to other tokens in the token database.

In some embodiments, the reservation electronic token is processed by a mobile electronic device of the store customer to claim the reserved item or service.

In some embodiments, the electronic communication is a text message sent from a mobile electronic device of the customer.

In some embodiments, the reservation determination module outputs a notification that includes information related to the reservation to the mobile electronic device of the store customer.

In another aspect, provided is a rental service reservation system, comprising: an instant rental service reservation system that receives an electronic communication from an electronic device of a store customer requesting an item or service rental reservation; and an analytics system that determines from the electronic communication whether the requested item or service is available for reservation, and generates a reservation recommendation to the instant rental service reservation system, wherein the instant rental service reservation system generates a reservation in response to the reservation recommendation.

In some embodiments, the instant rental service reservation system processes the electronic communication to identify and separate text data from the electronic communication that is used by the analytics system to generate the reservation recommendation.

In some embodiments, the analytics system includes a semantic and natural language processor for determining from the electronic communication reservation-related data, and wherein the reservation recommendation is generated from the reservation-related data.

In some embodiments, the natural language processor determines from keywords of the received electronic communication at least one of the item for reservation and a location of the item for reservation.

In some embodiments, the instant rental service reservation system further comprises a token processing module processes a reservation electronic token unique to the generated reservation.

In some embodiments, the token processing module compares the reservation electronic token to a token database to establish that the reservation is not duplicated.

In some embodiments, the instant rental service reservation system further comprises a storage device interface that communicates with the token database for at least one of storing the reservation electronic token or providing interface for the token processing module to compare the reservation electronic token to other tokens in the token database.

In some embodiments, the reservation electronic token is processed by a mobile electronic device of the store customer to claim the reserved item or service.

In some embodiments, the token is used by a reservation associate to determine reservation statistics.

In some embodiments, the token is stored in a cloud storage system that is accessible from the reservation location.

In some embodiments, the analytics system allows filtering of required items or services by retrieving and analyzing customer preferences, data on what other people have reserved, what items or services are available for the store near the customer, business inputs, or third party provider data.

In some embodiments, the rental service reservation system further comprises a notification system that generates and sends a notification to the store that the item for reservation has been reserved by the customer, and sends a notification to the customer's electronic device with a reservation confirmation.

In another aspect, provided is a method for reserving an item or service for rental, comprising: receiving an electronic communication from an electronic device of a store customer requesting an item or service rental reservation; determining text content from the electronic communication that includes reservation request data; determining whether the rental reservation request is feasible; and generating a reservation for the requested item or service in response to a determination that the rental reservation request is feasible.

In another aspect, provided is a method for generating a reservation, comprising: receiving a text message for a reservation of an item or service; determining from the text message a set of parameters of the reservation; and determining from the parameters whether a reservation token can be generated for use in reserving the item or service.

In another aspect, provided is a method for reserving an item or service for rental, comprising: requesting a reservation token; determining whether the reservation token is valid; confirming a reservation; and updating a reservation system to include the confirmed reservation.

### BRIEF DESCRIPTION OF THE SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts.

FIG. 1 is a diagram illustrating data exchanges between various elements of a store item rental reservation environment, in accordance with some embodiments.

FIG. 2 is a block diagram of an instant rental service reservation system, in accordance with some embodiments.

FIG. 3 is a flow diagram of a method for creating a reservation, in accordance with some embodiments.

FIG. 4 is a flow diagram of a method for confirming a reservation, in accordance with some embodiments.

FIG. 5 is a diagram illustrating data exchanges between various elements of a store item rental reservation environment, in accordance with some embodiments.

### DETAILED DESCRIPTION

In brief overview, an enterprise rental reservation system is provided that allows a customer to rent, lease, or temporarily acquire a store item or service in response to a text message or related electronic communication generated from an off-the-shelf application executed on the customer's computer device, for example, a text messaging application on a smartphone, and sent to a reservation system for processing. The text message is received and parsed so that relevant information in the text message is processed and analyzed. The analysis can be performed by an analytics system on the “clean” text data to acquire reservation data, which can be stored in real-time, and is used to determine the type of rental needed based on the text data and/or a comparison of other text messages, or whether a rental is possible at a retail establish of interest to the customer. The analytics system sends the relevant reservation data to the reservation system to generate a reservation electronic token and store the reservation information. In particular, the analytics system produces a result, or recommendation, that is sent to the reservation system, which includes data regarding whether the requested item or service may be reserved and/or other data, for example, where the item or service may be reserved if the desired location in the text message does not or cannot rent the item or service to the customer. The result may include alternative locations where a rental may be made. For example, if the customer desires to reserve an item of interest that is not currently available at a desired location, the system can automatically generate a list of other locations, for example, locations of approved partners where the item of interest may be reserved. The rental reservation system, in response, may generate an actual reservation, either at the store identified in the customer's original text message, or at a store identified in the analysis result. Provided also may include a token creation system that generates a unique electronic token that is processed by one or more network-connected processors for confirming a reservation, and which guarantees that no two reservations are the same.

For example, a customer may send a text message to reserve a carpet cleaning apparatus at a particular store on December 2 between 3 p.m. and 4 p.m. The system and method will analyze the request, look at the customer's location and compare the location to the requested store and other stores a predetermined distance from the customer, and generate a list of rentals that can be reserved for varying products that comply with the description of carpet cleaning apparatuses. The system may perform a search for all wet/dry vacuums on December 2^{nd} between 3 and 4 p.m. and may search for rental availability, pricing considerations, historical checks, and other information used for analysis of a received text message.

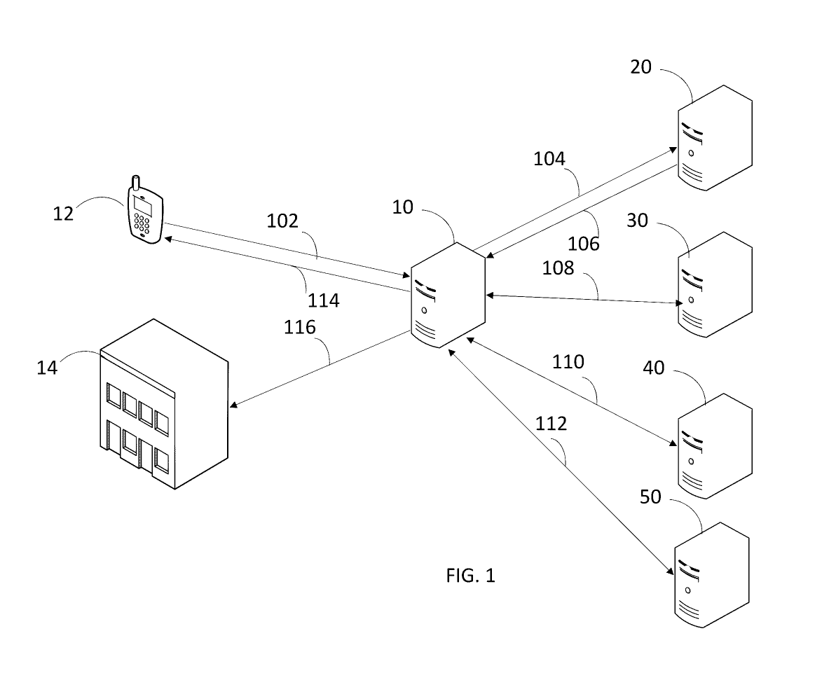

FIG. 1 is a diagram illustrating data exchanges between various elements of a store item rental reservation environment, in accordance with some embodiments.

The store item rental reservation environment may include but not be limited to an instant rental service reservation system 10, a reservation analytics system 20, a token creation system 30, a reservation storage device 40, and a notification system 50. In some embodiments, some or all of these elements of the environment are part of a same computer hardware platform. In other embodiments as shown in FIG. 1, these elements are located on two or more different computer hardware platforms, and can communicate with each other and/or other elements of the environment via a communication network (not shown), for example, wired or wireless network that exchanges data electronically between the instant rental service reservation system 10, reservation analytics system 20, token creation system 30, a reservation storage device 40, and notification system 50. Some or all of the elements, for example, the reservation storage device 40 and notification system 50, may be cloud-based, while other elements are resident at and managed by a store, customer, and/or other participating entity.

The instant rental service reservation system 10 processes electronic communications such as text messages received from a customer mobile electronic device 12, which may include a reservation request. For example, a customer may desire to rent a carpet cleaner or rent a service for cleaning a car, and may submit a text message with a request to rent the carpet cleaner or service. The text may include one or more keywords indicating a general interest by the store customer. An electronic communication may comply with a Short Message Service (SMS) or Multimedia Message Service (MMS), or related standard. The store item rental reservation system 10 may include or communicate with telephone or data communications devices that can process a phone number to which a text message is sent, and can also process related received data such as the customer's location, type of texting device, and so on.

In processing received electronic communications, the instant rental service reservation system 10 may identify actual text, i.e., characters, numbers, from the text message, and forward the resulting “clean” text data to the reservation analytics system 20, which in turn performs an analysis of the received text data to generate a reservation recommendation. The instant rental service reservation system 10 can generate a recommendation in response to receipt of a reservation recommendation generated by the analytics system 20 based on an analysis performed on the clean text data. The store item rental reservation system 10 also processes unique tokens received by the token creation system 30 that are used to confirm that reservations have been made and are valid.

As previously described, the reservation analytics system 20 analyzes received text data to determine from the text data a reservation for a product or service of interest to the customer making the request, and informs the reservation system 10 what is being reserved. Other information can be processed by the reservation analytics system 20 to determine an optimal reservation for a customer including rental rates, location of the item or service of interest, alternative items or services, and so on. In some embodiments, the analytics system 20 determines the type of rental needed based on text message contents and a comparison of texts, for example, stored at the reservation storage device 40, to infer the proper meaning of a text request, for example determine the type of rental needed and/or other relevant data.

The analysis may include filtering requested items and services from other text content. The analytics system 20 can determine the best reservation needed based on various customer inputs and geo-location information, for example, processing location information exchanged between the customer's mobile electronic device 12 and a location-based service. The analytics system 20 allows filtering of required items/services by retrieving and analyzing customer preferences, data on what other people have reserved, what items/services are available for the store near the customer, business inputs, third party provider data, and so on.

In some embodiments, the analytics system 20 includes a semantic and natural language processor for determining from keywords of the received text the item for reservation, in particular, distinguishing slang, tense, cultural differences, multiple definitions for the same term, and so on. Accordingly, the analytics system 20 can determine a kind of reservation a customer is asking for based on the payload sent from received text, what reservation items are located closest to the customer based on geo-location or other metric, and the best price based on reservations for that particular location. The analytics system 20 can take into account location, type of reservation, popularity of specific reservations, customer information, and so on.

The token creation system 30 generates a unique token for a customer making a reservation request, which is used to redeem the reservation at the location selected by the reservation system 10. A generated token can be used as a tracking mechanism for a reservation associate, business associate, or other interested party to determine which reservations are occurring the most frequently, etc.

The reservation storage device 40 stores tokens generated for customers, which can be subsequently retrieved for use by a customer when retrieving an item for rental as evidence that the item has been reserved. Stored token reservation data may be accessible for customers to review, for example, a reservation associate or customer to check for or confirm a reservation. The storage device 40 can be constructed and arranged to purge token data, for example, remove or update the system in a purging process to do determine when reservations are removed/updated based on customer activity, popularity of the reserved item, and so on. The storage device 40 can also store text messages for comparison purposes, for example, used for buying or renting analytics, or identifying trends in a store or market. For example, a store may receive many inquiries from customers for a particular item rental, and statistical data may be gathered.

The notification system 50 generates notifications regarding customer reservations. For example, the notification can notify the instant rental service reservation system 10 that a reservation token has been generated and stored for a customer. The notification system 50 can be configured to communicate with other reservation systems, for example, using representational state transfer (REST) service requests or the like. The notification system 50 can be integrated into a store system 14 for reservations. For example, when a reservation is made, the reservation system will send service requests to the local item inventory system to perform a transaction that includes renting the item/service as if it was processed at a point of sale (POS) terminal.

During operation, a customer may make a reservation (102) for a store item by communicating with the instant rental service reservation system 10. In doing so, the customer sends information via a text message or other electronic communication generated from the customer's mobile electronic device 12 to a specific number which may be stored, identified, and processed by the system 10 and/or other computer in communication with the system 10, for example, controlled by a service provider. The number is the phone number where the text message is directed to, and a central texting point where all electronic reservation text communications may flow through and processed. Other information may be determined based on the customer's location, texting device, the item or service identified for reserving, and so on. The central number can be static, i.e., the same number, for all reservations for the system 10. The information provided in the text message or related electronic communication may include information such as an item number, reservation type, description of reservation, location of customer, and so on.

The instant rental service reservation system 10 may process the received electronic communication data, distinguish information included in the received electronic communication, for example, characters, words, phrases, and numbers, from irrelevant content, and output (104) the necessary data, i.e., content useful in determining reservation-related information, to a language component, such as a natural language processor of the reservation analytics system 20, to determine what is being requested, tense, slang, and so on. The natural language processor combines artificial intelligence and computational linguistics related to interactions between one or more computers and human languages.

The reservation analytics system 20 performs an analysis of the text data received from the rental service reservation system 10 in order to determine the best type of reservation being asked, pricing, closest location, etc. The reservation analytics system 20 can generate a reservation recommendation for the customer, and output (106) the reservation recommendation to the instant rental service reservation system 10. The recommendation may be generated by the analytics system 20 comparing text data received from the customer mobile device and other acquired data such as inventory levels to determine where and when to make the reservation. The analytics system 20 can acquire data from other sources that is relevant to the generation of a reservation recommendation, for example, rental availability, pricing information, historical data such as other requests for the same or similar items, rules or laws pertaining to a reservation for example, determining whether the customer is at least 18 years old for operating heavy machinery of interest for rental, and so on.

In response to the instant rental service reservation system 10 receiving the reservation recommendation from the reservation analytics system 20, the instant rental service reservation system 10 can output a request (108) to the token creation system 30 to generate a unique reservation token for the customer making the reservation request via text message or the like from the mobile electronic device 12. The token generated includes all of the relevant information needed to redeem the reservation at the particular location.

In response to the instant rental service reservation system 10 receiving the reservation token generated at the token creation system 30, the instant rental service reservation system 10 can generate a request (110) that is output to the reservation storage device 40 to store the token information for the customer. The customer may acquire the token stored that a database or other repository of the reservation storage device 40 for confirming a reservation or otherwise providing evidence of a reservation when the customer visits the store to receive the item or service under the reservation. The notification system 50 can generate and output (112) a notification of the storage of the reservation token to the rental service reservation system 10, which may include a validation of the generation and storage of the reservation token, which in turn sends (114) reservation information to the mobile electronic device 12 including price, pickup information, and so on.

In response to the the instant rental service reservation system 10 receiving a notification and validation of the storage of the reservation, the instant rental service reservation system 10 can send a notification (116) to a store computer 14 of the store that has the item for reservation and information about the customer for pickup. The system 10 can check a store inventory in real-time using services from the system, or other locations in communication with the system.

The instant rental service reservation system 10 can optionally send the reservation information (114) (which may or may not be part of a notification) to the customer's mobile electronic device 12 which may include price, delivery, or other related details regarding the reservation.

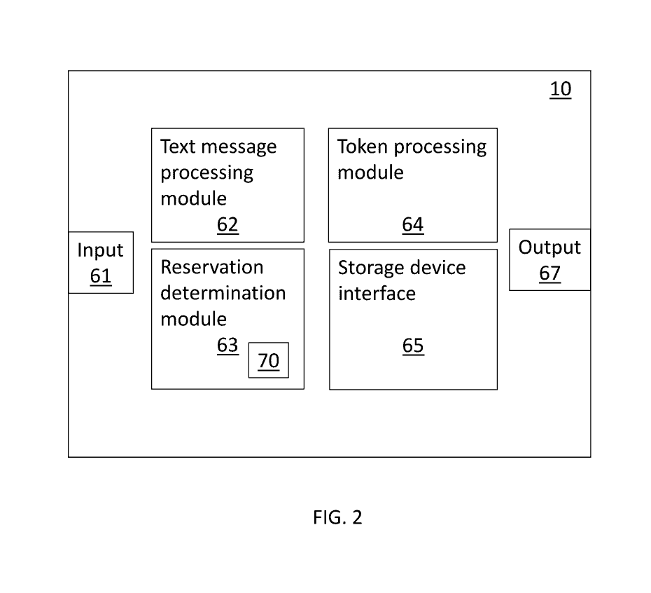

FIG. 2 is a block diagram of an instant rental service reservation system 10, in accordance with some embodiments. The instant rental service reservation system 10 can be implemented in the environment illustrated and described with respect to FIG. 1.

The instant rental service reservation system 10 may include a text message processing module 62, a reservation determination module 63, a token processing module 64, and a storage device interface 65. Some or all of these elements of the instant rental service reservation system 10 may be present under a same computer hardware platform, for example, having at least input port 61, at least one output port 67, and a memory and processor for storing and executing the elements of the system 10. In other embodiments, these elements may be located on two or more different computer hardware platform, and can communicate with each other and/or other elements of the instant rental service reservation system 10 via a communication network, for example, wired or wireless network that exchanges data electronically. For example, a business rule validator 70 described herein may be part of the analytics system 20 instead of the reservation determination module 63. In some embodiments, elements of the analytics system 20, the token creation system 30, the reservation storage device 40, and/or notification system 50 are part of the instant rental service reservation system 10.

The text message processing module 62 receives text messages or related electronic communications that include text data, and processes the text data by separating relevant content from irrelevant content of the electronic communication. For example, the text message processing module 62 may be constructed and arranged for parsing words, phrases, or other content and removes extraneous or irrelevant characters, strings, artifacts, graphics, and so on from the received messages.

The resulting “clean” text data is forwarded to the reservation analytics system 20, which in turn performs an analysis of the received text data to generate a reservation recommendation. An item or service can be identified for reservation by the customer based on a predetermined set of criteria or rules, including the one or more keywords. Criteria may include but not be limited to item location, price, type of reservation, popularity of item, or customer criteria. The analytics system 20 may include a natural language processor for determining from the one or more keywords the item for reservation according to the predetermined set of criteria or rules.

The reservation determination module 63 confirms whether reservation data is valid. Reservation data may include but not be limited to customer information, item information, price, availability, confirmation, and so on. The reservation determination module 63 may include a business rule validator 70 that establishes whether a requested rental is valid, whether too many reservations have been made for the same product or service. If the necessary or requested rental is not available at the primary retailer of choice, for example, the customer's favorite retail store or other established presence such as the closest store, then another party, such as a third party partner of the preferred retailer may fulfill the reservation. Here, the system 10 may generate the recommendation for the customer using the same interface, regardless of whether another store carries the item for rental and is identified in the reservation recommendation.

The business rule validator 70 can determine which items or services can be reserved. The analytics system 20 will determine if the item/service is available for reservation. The business rule validator 70 may process a result provided by the analytics system 20 in response to such a determination. The business rule validator 70 can limit the number of reservations in real time. The business rule validator 70 can provide data to the analytics system 20 do determine whether a reservation is acceptable in view of other reservations. For example, business input can be provided whether an item is available for reservation at to particular location due to local laws, company guidelines, or the like.

The token processing module 64 outputs a request to the token creation system 30 to generate a unique token identifier (ID) or other identifier for a customer making a reservation request. In some embodiments, the token processing module 64 determines whether a token submitted to confirm a reservation, for example, during retrieval of an item being rented, is indeed valid. In other embodiments, the token processing module 64 generates the unique token identifier (ID) instead of a separate token creation system 30. The token processing module 64 may confirm a token by comparing the token to a token database or other repository of the reservation storage device 40. The token includes all relevant reservation information needed to redeem the reservation at the particular location identified in the reservation recommendation generated by the analytics system 20. The token processing module 64, in response to receiving the generated reservation token ID, can make a request to the reservation storage device 40 to store the token information for the customer to be able to use when picking up the item or service corresponding to the reservation. The reservation determination module 63 may receive a validation from the storage device 40 of the storage of the reservation token ID, which in turn communicates with the notification system 50 to send a notification to the store that has the item for reservation and information about the customer for pickup.

The storage device interface 65 is constructed and arranged for communicating with the storage system 40 for storing electronic/digital reservation tokens at a token database or other repository of the reservation storage device 40, and/or retrieving reservation tokens from the storage system 40.

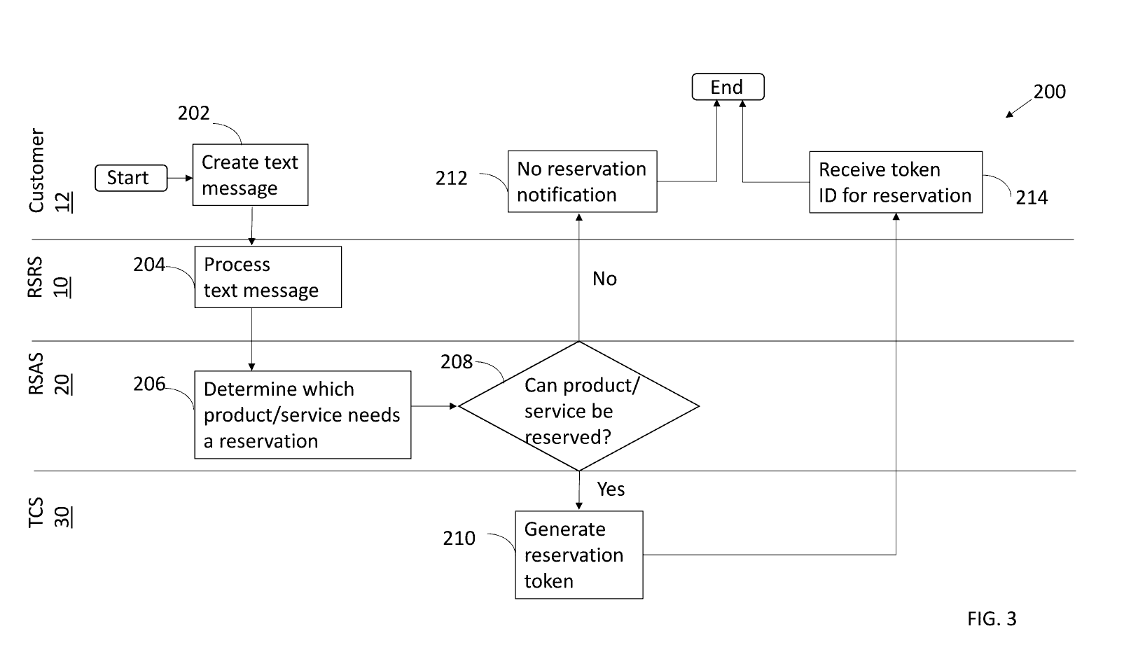

FIG. 3 is a flow diagram of a method 200 for creating a reservation, in accordance with some embodiments. Some or all of the method 200 can be performed at the instant rental service reservation system 10 of FIGS. 1 and 2, and/or other elements of the environment illustrated in FIG. 1. The method 200 can be governed by instructions that are stored in a memory device of the instant rental service reservation system (RSRS) 10 of FIGS. 1 and 2, and/or other elements of the environment illustrated in FIG. 1, and executed by a hardware processor of the instant rental service reservation system 10 of FIGS. 1 and 2, and/or other elements of the environment illustrated in FIG. 1.

At block 202, a text message is created at a mobile electronic device 12 of a user interested in reserving an item or service of interest at a store 14 or other location at which the item or service may be acquired. Although a text message is described, other electronic communications in which characters, numbers, symbols, or other exchanged can equally apply.

At block 204, the rental service reservation system 10 processes the text message, and outputs the processed text message to the rental service analytics system (RSAS) 20. All data sent from the text message, e.g., phone number, body of text message, location, can be sent to the rental service analytics system 20 without any “unacceptable” data such as junk characters that can't be processed.

At block 206, the rental service analytics system 20 determines the parameters of the reservation. For example, a text message may be sent that states “I want to reserve a wet/dry vacuum on December 2nd at 3:56 PM”. Here, the analytics system 20 can, in response, check the system for all wet/dry vacuums on December 2nd between 3 and 4 PM, as well as availability of the vacuum. The system may recognize the terms or phrases, and generate results accordingly using a natural language processor or the like.

At decision diamond 208, a determination is made by the rental service analytics system 20 whether the product or service identified from the received text message can be reserved. If yes, then the method 200 proceeds to block 210, where the product/service is reserved with a unique token ID generated electronically by the token creation system 30, for example, a 32 byte number, character set, symbols, or combination thereof, which can be used by the customer to redeem or receive the product or service for rental under the reservation. In other words, the analytics system 20 sends the relevant reservation data to the reservation system 10 to generate a token and store the reservation information. At block 214, the customer receives the token ID for the reservation to be redeemed at the store 14.

If at decision diamond 208, a determination is made by the rental service analytics system 20 that the product or service identified from the received text message cannot be reserved, then the method 200 proceeds to block 212, where the rental service reservation system 10 generates a notification that is sent to the customer's mobile electronic device 12 that the product/service of interest made in the text message cannot be rented. An explanation may be provided with the notification, for example, the item/service is not available at the location identified in the text message, or at time/date, and so on.

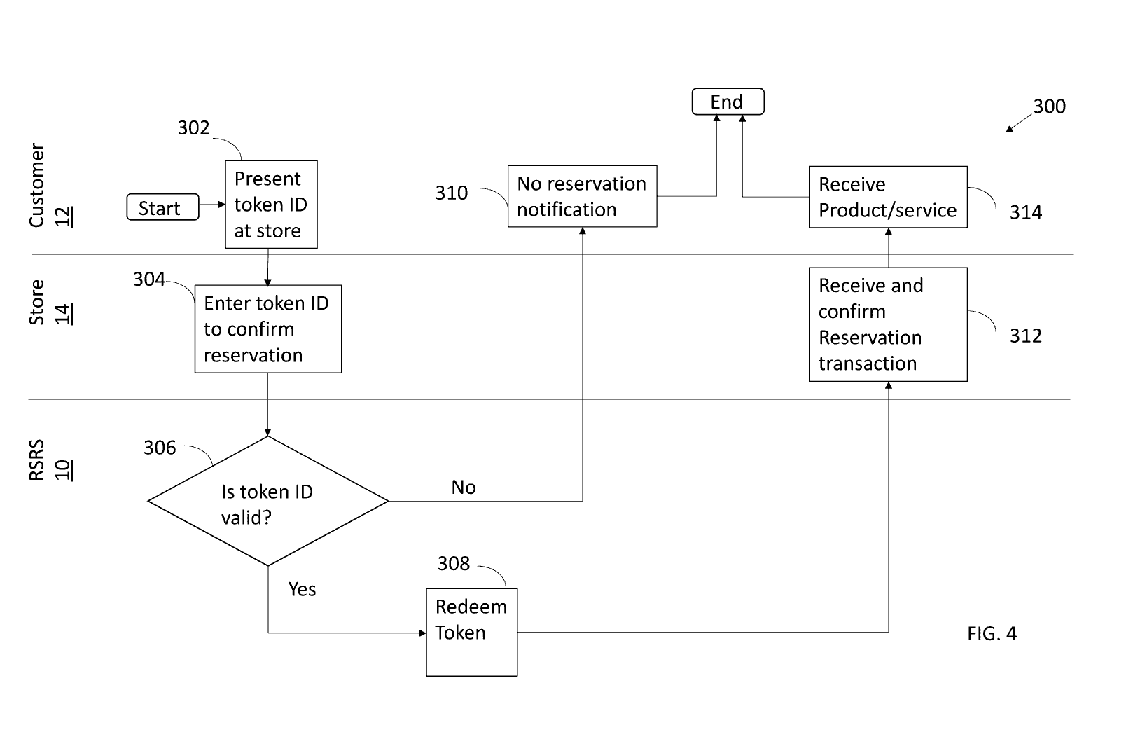

FIG. 4 is a flow diagram of a method 300 for confirming a reservation, in accordance with some embodiments. Some or all of the method 300 can be performed at the instant rental service reservation system 10 of FIGS. 1 and 2, and/or other elements of the environment illustrated in FIG. 1. The method 300 can be governed by instructions that are stored in a memory device of the instant rental service reservation system 10 of FIGS. 1 and 2, and/or other elements of the environment illustrated in FIG. 1, and executed by a hardware processor of the instant rental service reservation system 10 of FIGS. 1 and 2, and/or other elements of the environment illustrated in FIG. 1.

At block 302, a reservation token ID, for example, the token ID provided to the customer 12 at block 214 in FIG. 3, may be presented at a store 14 that can be used by the customer 12 to claim a reservation. A token may be presented by typing in from a computer terminal, scanning a barcode from the customer's mobile electronic device, e.g. smartphone, or by a store associate using an electronic device such as a personal computer to search a database for all active electronic tokens for a customer.

At block 304, the reservation token ID is processed by a store rental service system at, or otherwise in communication with one or more computer processors at, the store 14 in order to confirm the reservation. The store rental service system may communicate with the rental server reservation system 10, or otherwise be part of the instant rental service reservation system 10.

Accordingly, at decision diamond 306, the instant rental service reservation system 10, for example, the token processor 64 illustrated in FIG. 2, determines whether the reservation token ID submitted by the customer 12 is valid. If the submitted reservation token ID is determined to be valid, then the method 300 proceeds to block 308, where the token ID may be redeemed. The store associate may be provided information, for example, from the instant rental service reservation system 10, for processing the reservation made by the customer 12. Otherwise, the method 300 proceeds to block 310, where the reservation is not processed. Instead, the customer 12 may receive at an electronic device a notification that the reservation does not exist.

Returning to block 308, after the token is redeemed, the method 300 may proceed to block 312, where the store associate may process the reservation transaction. At block 314, the customer may receive the reserved product or service.

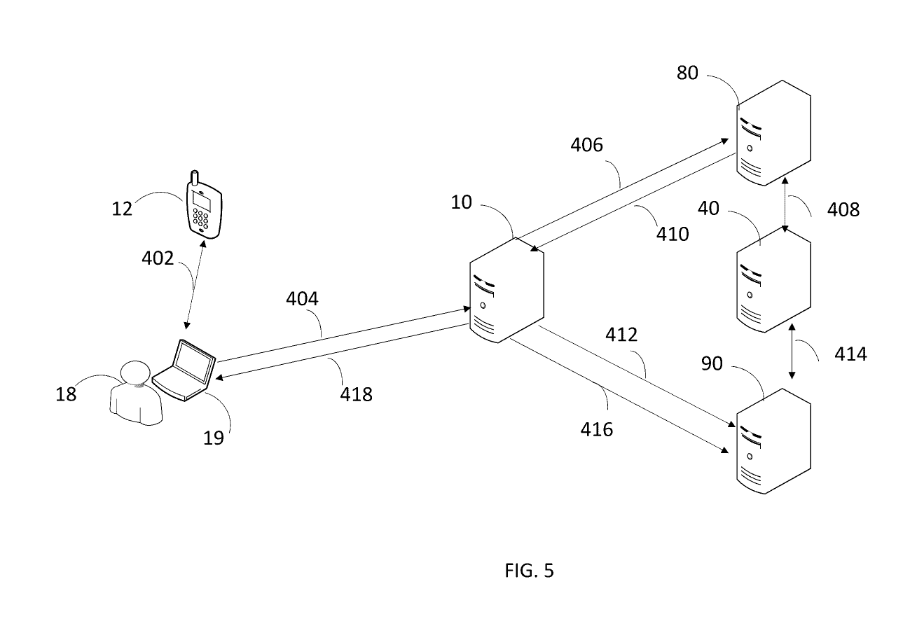

FIG. 5 is a diagram illustrating data exchanges between various elements of a store item rental reservation environment, in accordance with some embodiments. In describing the data exchanges, reference may be made to elements of FIGS. 1-4. A reservation is made according to some embodiments prior to performing an operation described in FIG. 5.

During operation, a reservation associate 18 may ask (402) a customer, for example, via an electronic communication between the reservation associate's computer 19 and the customer's mobile electronic device 12, for a phone where a reservation token ID is displayed. This may be beneficial in a text generation application, and interacting with the same electronic device 12 that initiated the reservation request.

The reservation associate 18 can scan or other (404) enter the reservation token using a scanning device or the like in connection with the associate's computer 19 into the instant rental service reservation system 10 for processing. When processing the token, other processes may be performed, for example, the reservation is completed, a transaction log may be generated and stored, the reservation may be confirmed, and the store inventory may be updated.

The instant rental service reservation system 10 sends (406) the token information to a rental reservation lookup system 80 for processing.

The rental reservation lookup system 80 sends (408) the token information to the reservation storage device 40 to confirm that the reservation is still valid. When the token is output to the storage device 40, the reservation system 10 may determine if the token is valid and and if it links to the customer making the reservation. If it does, then the processing continues. If it doesn't, then the reservation is not valid and processing stops. The rental reservation lookup system 80 may receive a confirmation from the reservation storage device 40, and in response, send (410) the information back to the instant rental service reservation system 10 for processing, for example, completing the reservation and so on.

Once the instant rental service reservation system 10 confirms that the reservation data is valid, for example, comparing a generated token against a token database, the instant rental service reservation system 10 sends (412) the token confirmation information to a rental reservation confirmation system 90. In other embodiments, instead of comparing tokens, a determination is made whether a reservation token pertaining to a same reservation is stored at the token database, for example, part of the storage device 40, in order to establish whether the reservation is a duplicate, and prior to generating the token for the reservation. The rental reservation confirmation system 90 sends (414) the confirmation information to the reservation storage device 40 to be stored and updated for rental/reservation details. As described herein, rental data may be output to the analytics system 20, which can generate metrics on the popularity of that particular rental in that area, how often it's rented out, symantic analysis of the text sent and how it aligns to the final reservation, and/or other analytic data. The system 10 may select a metric of interest in order to generate reservations, which provides higher accuracy for the customer expressing interest in reserving an item or service via text message, and may also benefit from having a rental in stock for more popular items, or at popular times or dates.

The rental reservation confirmation system 90 sends (416) a final confirmation information back to the instant rental service reservation system 10 for a final update to the associate 18. Here, services are called on the backend system for updating the reservation information as well as the analytics system 20 for future processing on other reservations and received text messages.

The instant rental service reservation system 10 sends (418) the final confirmation information to the reservation associate 18 to show to the customer to pick up the reserved item(s).

While concepts have been shown and described with reference to specific preferred embodiments, it should be understood by those skilled in the art that various changes in form and detail may be made therein without departing from the spirit and scope as defined by the following claims.

What is claimed is:

1. An instant rental service reservation system, comprising:
an input for receiving an electronic communication from an electronic device of a store customer requesting an item or service rental reservation;
a text message processing module that generates revised text data by removing irrelevant content from the electronic communication, the revised text data including reservation request data; and
a reservation determination module that generates a reservation from a reservation recommendation, the reservation recommendation generated in response to an analysis of the reservation request data of the revised text data.

2. The instant rental service reservation system of claim 1, further comprising a token processing module processes a reservation electronic token unique to the generated reservation.

3. The instant rental service reservation system of claim 2, wherein the token processing module compares the reservation electronic token to a token database to establish that the reservation is not duplicated.

4. The instant rental service reservation system of claim 3, further comprising a storage device interface that communicates with the token database for at least one of storing the reservation electronic token or providing interface for the token processing module to compare the reservation electronic token to other tokens in the token database.

5. The instant rental service reservation system of claim 2, wherein the reservation electronic token is processed by a mobile electronic device of the store customer to claim the reserved item or service.

6. The instant rental service reservation system of claim 1, wherein the electronic communication is a text message sent from a mobile electronic device of the customer.

7. The instant rental service reservation system of claim 6, wherein the reservation determination module outputs a notification that includes information related to the reservation to the mobile electronic device of the store customer.

8. A rental service reservation system, comprising:
an instant rental service reservation system that receives an electronic communication from an electronic device of a store customer requesting an item or service rental reservation; and
an analytics system that determines from the electronic communication whether the requested item or service is available for reservation, and generates a reservation recommendation to the instant rental service reservation system, wherein the instant rental service reservation system generates a reservation in response to the reservation recommendation.

9. The rental service reservation system of claim 8, wherein the instant rental service reservation system processes the electronic communication to identify and separate text data from the electronic communication that is used by the analytics system to generate the reservation recommendation.

10. The rental service reservation system of claim 8, wherein the analytics system includes a semantic and natural language processor for determining from the electronic communication reservation-related data, and wherein the reservation recommendation is generated from the reservation-related data.

11. The rental service reservation system of claim 8, wherein the natural language processor determines from keywords of the received electronic communication at least one of the item for reservation and a location of the item for reservation.

12. The rental service reservation system of claim 8, wherein the instant rental service reservation system further comprises a token processing module processes a reservation electronic token unique to the generated reservation.

13. The rental service reservation system of claim 12, wherein the token processing module compares the reservation electronic token to a token database to establish that the reservation is not duplicated.

14. The rental service reservation system of claim 13, wherein the instant rental service reservation system further comprises a storage device interface that communicates with the token database for at least one of storing the reservation electronic token or providing interface for the token processing module to compare the reservation electronic token to other tokens in the token database.

15. The rental service reservation system of claim 12, wherein the reservation electronic token is processed by a mobile electronic device of the store customer to claim the reserved item or service.

16. The rental service reservation system of claim 12, wherein the token is used by a reservation associate to determine reservation statistics.

17. The rental service reservation system of claim 12, wherein the token is stored in a cloud storage system that is accessible from the reservation location.

18. The rental service reservation system of claim 8, wherein the analytics system allows filtering of required items or services by retrieving and analyzing customer preferences, data on what other people have reserved, what items or services are available for the store near the customer, business inputs, or third party provider data.

19. The rental service reservation system of claim 8, further comprising a notification system that generates and sends a notification to the store that the item for reservation has been reserved by the customer, and sends a notification to the customer's electronic device with a reservation confirmation.

20. A method for reserving an item or service for rental, comprising:
receiving an electronic communication from an electronic device of a store customer requesting an item or service rental reservation;
determining text content from the electronic communication that includes reservation request data;
determining whether the rental reservation request is feasible; and
generating a reservation for the requested item or service in response to a determination that the rental reservation request is feasible.
